(19) United States
(12) Patent Application Publication
(10) Pub. No.: US 2006/0185237 A1
(43) Pub. Date: Aug. 24, 2006

(54) Plant growing material

(75) Inventors: Rene Mario van der Meulen, Amstelveen (NL); Davy Nicolaas Johannes de Witt, Leiderdorp (NL); Albert van Duijn, Oegstgeest (NL)

Correspondence Address: NORRIS, MCLAUGHLIN & MARCUS, P.A., 875 THIRD AVE, 18TH FLOOR, NEW YORK, NY, 10022, US

(73) Assignee: Netherlandse Organisatie voor toegepast- natuurweten schappelijk Onderzoek TNO, Delft (NL)

(21) Appl. No.: 10/548,337

(22) PCT Filed: Mar. 5, 2004
(86) PCT No.: PCT/NL04/00165

§ 371 Date: Sep. 7, 2005

(30) Foreign Application Priority Data
Mar. 7, 2003 (NL) 1022874

(51) Int. Cl. A01G 31/00

(52) U.S. Cl. 47/59 S

(57) ABSTRACT

A growing material for plants comprising a coherent substrate material for including and therein roots of a plant to be supported by the substrate material, wherein in the substrate, locally, provisions (4) have been embedded which are manufactured from a material impenetrable by roots and are, at least partly, surrounded by material penetrable by roots, thereby forming, locally, embedded, in the substrate for the roots, a layer in the form of a porous net-shaped or sieve-shaped barrier so that during growing the roots are forced to deflect and bend through the porous net-shaped or sieve-shaped barrier, thereby spreading over the substrate material in an optimal manner and growing roots therein more intensively.

The invention relates to a growing material for plants comprising a coherent substrate material penetrable by roots for receiving and surrounding therein the roots of a plant to be supported by this substrate material.

When growing plants it is known, certainly in present-day glasshouse horticulture, to use substrates instead of soil for the root formation of the plants to be cultivated. As material for the substrate rock wool, glass wool, coco material, stone wires, cell foam, fibers et cetera as well as mixtures of these materials in block shape or mat shape can be considered. A condition is, on the one hand, that the substrate material is sufficiently coherent for supporting the plants and, or the other hand, that the roots can penetrate the substrate material. The substrate material should further be such that it can take up water with nutrients and pass this on to the roots of the plants. Thus, the supplied nutrients can be accurately distributed and regulated. A further advantage is that use can be made of an inert material which is free and can remain free of any pathogens present in cultivating soil.

With the invention, an improved growing material of the type described in the preamble is contemplated.

According to the invention this is obtained when in the substrate, locally, provisions have been embedded which are manufactured from a material which is impenetrable by the roots and at least partly surrounded by material which is penetrable by roots, thereby forming, locally, embedded in the substrate for the roots, a layer in the form of a porous, net-shaped or sieve-shaped barrier.

Research has shown that roots in a substrate material have the tendency to grow straight downwards without or with a limited number of branches, so that at the bottom side of the layer of substrate material a ball of roots is formed. Further, water supplied to the substrate material also has the tendency to drift downwards, so that the situation can arise that the larger part of the roots of a plant is surrounded by stagnant water.

By presently, according to the present invention, providing, locally, areas which are impenetrable by the roots, these can no longer grow straight downwards in an unhindered manner, but are forced by the layer-shaped, porous net-shaped or sieve-shaped barrier to deflect sideways and to bend, which results in several and multiple branched roots, i.e. the roots spread over a larger area and the substrate material is penetrated by roots more completely; therefore more or less according to the growth of roots in heterogeneous soil. In fact, the bottom of the substrate block or substrate layer is elevated and made penetrable locally. The ball of roots initially present on the bottom is now present above the porous net-shaped or sieve-shaped barrier but it can penetrate it and then grow perpendicularly downwards according to the natural pattern, albeit, now, uniformly distributed over the cross section of the substrate. Due to the larger amount of branched roots in, in particular, the upper part of the substrate material, the volume of the substrate to be maximally used, which is used for, for instance, water, nutrient and oxygen uptake by the roots, is considerably enlarged resulting in more abundantly and healthier growing plants, which also enhances the productivity of fruit-bearing plants, such as, for instance, cucumbers.

According to a further embodiment of the invention, in order to optimize the spreading and branching of roots in transverse direction of the substrate, it is preferred that the porous net-shaped or sieve-shaped barrier has an upper surface extending substantially transverse to the main direction of growth of the roots. Realizing such a porous net-shaped or sieve-shaped barrier can be done in a relatively simple manner, when the porous net-shaped or sieve-shaped barrier forms a horizontal separating layer in the substrate, or, conversely, extends downwards in a curving manner from a central crown top into the substrate material, it further being preferred that in the area of its crown top, the porous net-shaped or sieve-shaped barrier is designed so as to be uninterrupted.

For such a branched root growth to be obtained in the substrate material, the roots should not be able to push aside the impenetrable provisions. Therefore, if the substrate material does not have an intrinsic securing effect on those provisions, it can be preferred according to a further embodiment of the invention, that the provisions are provided so as to be anchored, at least substantially not movable within the substrate material.

The form and manner of growth of the roots can be influenced in accordance with the desired object when, according to a further embodiment of the invention, the impenetrable barrier has been provided in the substrate material as locally distributed, embedded obstacles. With the packing density and distribution of the obstacles, the growth of the roots can then be influenced in the desired manner.

In order to have deflection by blocking the root growth through creation of a mechanical resistance not be a growth impediment but, conversely, a stimulation of the spreading and branching, it can be advantageous according to a further embodiment of the invention to provide the obstacles with a smooth surface. This effect can be further enhanced when the obstacles have a spherical configuration. The obstacles can then be manufactured from, inter alia, stone. However, according to the invention, it is particularly preferred that the obstacles consist of glass pearls. They form highly effective, impenetrable obstacles to roots, which, however, in addition thereto, due to their smooth spherical shape, create optimal circumstances for the root growth to take place in the desired shape, branching out and spreading over the substrate material.

In addition, according to a further embodiment of the invention, it is also possible that the impenetrable barrier is formed from a similar inert material to the substrate, but having a considerably higher density, i.e. a density impenetrable by the roots, than the surrounding substrate material which is penetrable by the roots.

Instead of a mechanical blocking of the root growth, also a chemical barrier can be chosen. According to a further embodiment of the invention this can be realized when the impenetrable barrier consists of at least one chemical layer, more in particular a hormone layer. A combination of mechanical and chemical blocking can also be opted for. The porous net-shaped or sieve-shaped barrier can then consist of an inert material to which a chemical layer, for instance a plant hormone, has been applied.

As stated, the roots have the tendency to grow downwards as rapidly as possible into the substrate material. In order to undo this tendency as rapidly as possible, according to a further embodiment of the invention, it is in particular preferred that the porous net-shaped or sieve-shaped barrier is located at least directly below and/or in the proximity of a plant hole provided in the substrate material.

With reference to an exemplary embodiment represented in the accompanying drawing, the growing material according to the invention will presently be elucidated further, albeit exclusively by way of non limitative example. In the drawing:

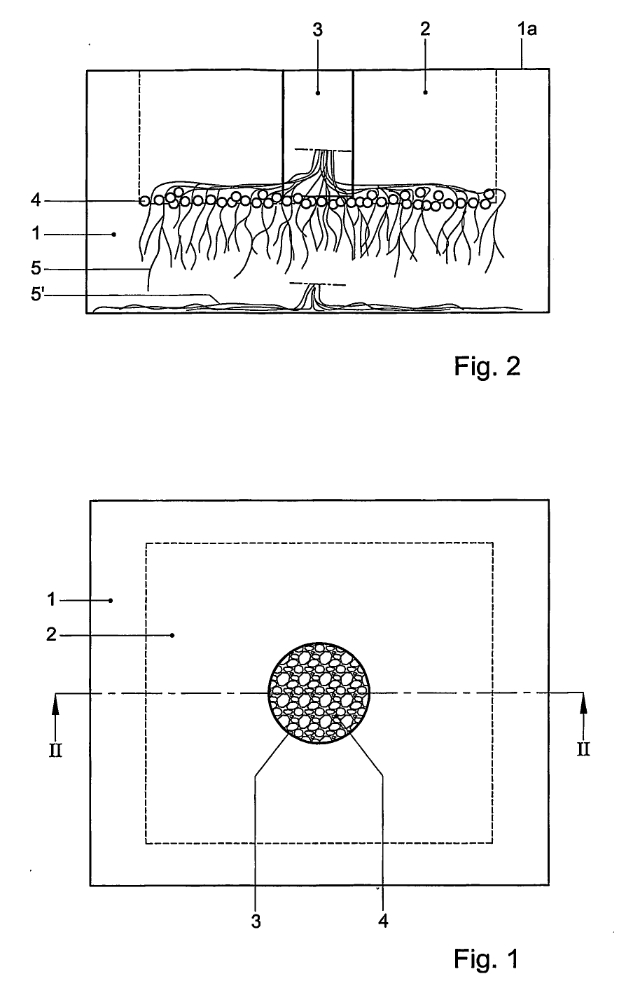

FIG. 1 shows a top plan view of a block of growing material according to be invention; and

FIG. 2 shows a cross section along line II-II in FIG. 1.

In the Figures, a rectangular block 1 of growing material is represented, while a substrate material such as, for instance, rock wool, glass wool, coco material, rock wires, cell foam, fibres and the like can be considered, from which, starting from upper surface la, symmetrically, a smaller rectangular block 2 has been cut, provided in its center with a plant hole 3, in which sowing can take place or in which a pressed pot with a germinating plant can be placed for the purpose of cultivating the plant (further). On the bottom of the recess in the block 1 obtained by cutting out the block 2, a layer of glass pearls 4 is provided whereupon the block 2 with the plant hole 3 provided therein is placed back into the block.

During growing, the roots of a plant encounter the layer of glass pearls 4 and are forced to grow around those glass pearls 4. This results in a branching and spreading of the roots over the layer of glass pearls 4 resulting in a network of roots branching and spreading at the location of the layer of glass pearls 4, as indicated in FIG. 2 with reference numeral 5, and which spreads further downwards from this level over the block 1 through the layer of glass pearls 4. This in contrast with a situation wherein the layer of glass pearls 4 would have been omitted. Then, the roots would grow downwards substantially without or with hardly any branches to the lower side of the block 1 and there, halted by the support layer (not represented) onto which the block 1 has been placed, spread sideways, as indicated in FIG. 2 with reference numeral 5′.

As water has the tendency to drift downwards in such a substrate material, a root network 5′ would then be surrounded by water, which would negatively affect the desired oxygen uptake by the roots. Due to the layer of glass pearls 4, a root network 5 is obtained which already has multiple branches at a higher level and has spread more over the block 1. As a result, it is possible to use the volume of the substrate as optimally as possible for, for instance, uptake of water, nutrients and oxygen by the roots, resulting in a more abundant and healthier growing plant, which also enhances the productivity of fruit-bearing plants, such as, for instance, cucumbers.

It is self-evident that within the framework of the invention as laid down in the accompanying claims, in addition to the already described variants, many further modifications and variants are possible. For instance, the impenetrable provisions can be composed from obstacles. Also, combinations of mechanical and chemical obstacles are possible. Although in the exemplary embodiment a single layer of glass pearls is represented, such layers can also be provided on several levels. These layers need not, as shown, have a flat configuration but can also be of curved design, for instance partly spherical or elliptical with the crown centrally below the ball of roots coming from the plant. Naturally, it is also possible to realize the porous net-shaped or sieve-shaped barrier in another manner than by applying a layer of glass pearls. Also, other manners of realization than cutting the block from another block are possible. For instance, composing a block of growing material from successive layers can be considered. In the exemplary embodiment, a layer of glass pearls is shown extending over a relatively large area. However, also other uses are conceivable in which the application of such a layer or a similar layer with a smaller size, for instance only at the location of the plant hole, are a possibility.

1. A growing material for plants comprising a coherent substrate material penetrable by roots for including and surrounding therein roots of a plant to be supported by the substrate material, characterized in that, locally, in the substrate, provisions have been embedded which are manufactured from a material impenetrable by roots, and, at least partly, are surrounded by material penetrable by roots, thereby forming, locally, embedded in the substrate for the roots, a layer in the form of a porous net-shaped or sieve-shaped barrier.

2. A growing material according to claim 1, characterized in that the porous net-shaped or sieve-shaped barrier has an upper surface extending substantially transverse to the main direction of growth of the roots.

3. A growing material according to claim 1, characterized in that the porous net-shaped or sieve shaped barrier forms a horizontal separating layer in the substrate.

4. A growing material according to claim 1, characterized that the porous net-shaped or sieve-shaped barrier extends downwards in a curving manner from a central crown top into the substrate material.

5. A growing material according to claim 4, characterized in that the porous net-shaped or sieve-shaped barrier in the area of its crown top is designed so as to be uninterrupted.

6. A growing material according to claim 1, characterized in that the provisions are anchored, at least embedded in the substrate material in a substantially non-moveable manner.

7. A growing material according to claim 1, characterized that the porous net-shaped or sieve-shaped barrier is provided in the substrate material as locally distributed, embedded obstacles.

8. A growing material according to claim 7, characterized in that the obstacles have a smooth surface.

9. A growing material according to claim 7, characterized in that the obstacles have a spherical configuration.

10. A grow material according to claim 7, characterized in that the obstacles are manufactured from stones, at least partly.

11. A growing material according to claim 7, characterized in that obstacles consist of glass pearls, at least partly.

12. A growing material according to claim 1, characterized that the porous net-shaped or sieve-shaped barrier is formed from a similar inert material to the substrate, yet has a considerably higher density, i.e. density impenetrable by the roots, than the surrounding substrate material which does allow the roots through.

13. A growing material according to claim 1, characterized in that the porous net-shaped or sieve-shaped barrier consist of at least one chemical layer, more in particular a hormone layer.

14. A growing material according to claim 1, characterized in that the porous net-shaped or sieve-shaped barrier is located at least
